(19) United States
(12) Patent Application Publication
(10) Pub. No.: US 2003/0142663 A1
(43) Pub. Date: Jul. 31, 2003

(54) System and method for providing distributed HDT-RT networks

(75) Inventors: Jean-Francois Gallant, Ottawa (CA); Ray Mak, Gloucester (CA); John Donak, Kanata (CA); Michael Gazier, Nepean (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Catena Networks, Inc., Redwood Shores, CA

(21) Appl. No.: 10/319,423

(22) Filed: Dec. 12, 2002

(30) Foreign Application Priority Data
Dec. 12, 2001 (CA) 2,364,905

(51) Int. Cl. H04L 12/66

(52) U.S. Cl. 370/353; 370/401

(57) ABSTRACT

A distributed system for communicating between a host digital terminal and a remote terminal. The host digital terminal is coupled between a central office digital terminal and a distribution network. The remote terminal is coupled between the distribution network and a plurality of subscriber loops. The system further includes a first network interface in communication with the host digital terminal for translating between an interface group protocol and a gateway control protocol. A distribution network switching fabric routes data between the host digital terminal and the remote terminal. A second network interface is in communication with the remote terminal for performing commands received from the first network interface and responding accordingly. Such a system enhances the evolution to next-generation packet networks.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates generally to telecommunications networks, and specifically to a system and method for decomposing a remote digital terminal (RDT) into remote terminal (RT) and host digital terminal (HDT) components.

Referring to FIG. 1, an industry standard configuration of an Integrated Digital Loop Carrier (IDLC) is illustrated generally by numeral 100. The IDLC includes an Integrated Digital Terminal (IDT) 102 located at or near a central office (CO) and a Remote Digital Terminal (RDT) 104 located at or near a customer neighborhood. The IDT 102 is coupled to a Public Switched Telephone Network (PSTN) 105. The IDT 102 is further coupled to the RDT 104 via a high-speed digital circuit 106 such as a T1 circuit. The RDT 104 is further coupled to a plurality of customer loops 108.

Media traffic between the customer loops 108 and the PSTN 105 is collated by the RDT 104 and multiplexed over the T1 circuit 106 to the IDT 102. In some configurations, the RDT 104 supports several T1 circuits 106, with each T1 circuit 106 coupled with a different IDT 102.

The RDT 104 is an intelligent network element that interfaces between customer access lines and Time Division Multiplexing (TDM) facilities. The RDT 104 includes a Host Digital Terminal (HDT) and a Remote Terminal (RT). The HDT terminates interfaces to the TDM facilities, which interface to the PSTN 105 while aggregating traffic from one or more RTs. The RT connects to the customer loops 108 and aggregates the analog signals by multiplexing them into a digital transport facility, which supports TDM, Asynchronous Transport Mode (ATM), Internet Protocol (IP) bearer path, and the like.

Primarily, telecommunications systems have been implemented using TDM as the carrier technology of choice. TDM technology divides the available bandwidth into timeslots and assigns a predefined timeslot to each subscriber line. The subscriber line transmits its data to the network during its assigned timeslot. As such, existing access devices normally provide a TDM interface to the network in the form of T1 or T3 carrier links. However, as the amount of data traffic travelling over public packet networks outgrows voice traffic, new access devices have become available that provide connectivity to next-generation packet networks, thereby enabling call services to be provided over a packet network.

However, although a trend is developing towards next-generation packet network to provide voice communication, there are still many legacy systems that are reluctant to make such a switch. Thus, this limitation has left service providers with an obligation to keep and maintain legacy access equipment in parallel with next-generation access equipment, and to follow a costly and inefficient migration path that requires physically moving subscriber lines from the legacy equipment to the packet-network access device. This difficulty discourages service providers from adopting next-generation packet networks, thereby delaying the introduction of new call services that a packet-based infrastructure would make possible.

Further, it is generally difficult to unbundle loops that use IDLC technology. An unbundled loop is a loop that is owned by an incumbent service provider but leased to an alternate service provider. This service is normally relegated to the use of proprietary control mechanisms. However, these proprietary control mechanisms do not often meet many requirements, in that they do not allow interoperability with third party products, nor support evolution to next-generation packet networks. It is an object of the present invention to obviate or mitigate at least some of the above mentioned disadvantages.

It is an object of the present invention to obviate or mitigate at least some of the above-mentioned disadvantages.

### BRIEF SUMMARY OF THE INVENTION

In accordance with an aspect of the present invention, there is provided a distributed system for communicating between a host digital terminal and a remote terminal. The host digital terminal is coupled between a central office digital terminal and a distribution network. The remote terminal is coupled between the distribution network and a plurality of subscriber loops. The system further includes a first network interface in communication with the host digital terminal for translating between an interface group protocol and a gateway control protocol. A distribution network switching fabric routes data between the host digital terminal and the remote terminal. A second network interface is in communication with the remote terminal for performing commands received from the first network interface and responding accordingly.

It is an advantage of the present invention that there is provided a system architecture for supporting the evolution to next-generation packet networks and unbundling loops while maintaining interoperability with third party products. Typically, alternate service providers are challenged to access their IDLC-served customers' signals in a digital format without collocation or converting an IDLC-served customer to all copper facilities or an older form of DLC, which can degrade the customer's service. The system and methods described herein offer digital signal handoff in a distributed host digital terminal/remote terminal network.

### BRIEF DESCRIPTION OF THE DRAWINGS

Embodiments of the invention will now be described by way of example only with reference to the following drawings in which:

FIG. 1 is a block diagram of an IDLC in a TDM network (prior art);

FIG. 2 is a block diagram of an IDLC in a TDM network having distributed RDTs;

FIG. 3 is a block diagram illustrating the use of an internetworking function in the network illustrated in FIG. 2; and

FIG. 4 is a block diagram of loop unbundling architecture in a TDM network having distributed RDTs.

### DETAILED DESCRIPTION OF THE INVENTION

For convenience, like numerals in the description refer to like structures in the drawings. Referring to FIG. 2, a distributed RDT network is illustrated generally by numeral 300. The distributed RDT network 300 includes a plurality of remote terminals 302, host digital terminals 304, integrated digital terminals 306, a distribution network 308, and a public switched telephone network (PSTN) 105. The network further includes a softswitch 310 and a trunking gateway 312. Each of the remote terminals 302 can be coupled with a host digital terminal 304 via the distribution network 308. Each of the host digital terminals 304 is coupled with at least one corresponding integrated digital terminal 306. The integrated digital terminals 306 are coupled to the PSTN 105.

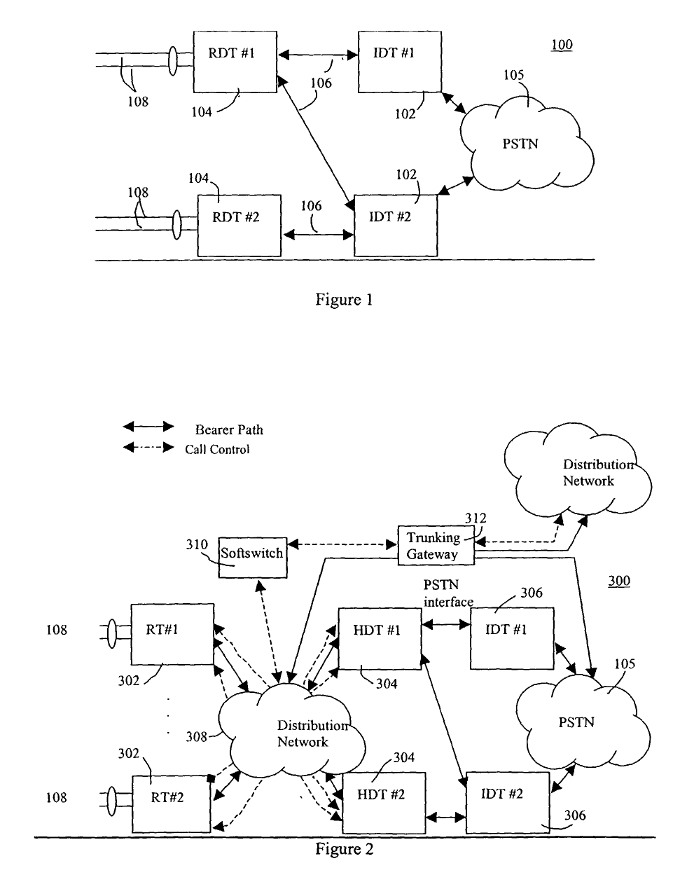

Generally, a remote digital terminal 104 is used to provide access between customer loops, which may be either residential or business, and a centralized network of components, as described above regarding FIG. 1. In order to provide a greater span of control, the remote terminal 302 is subtended from one or more host digital terminals 304. This is achieved via the distribution network 308. The distribution network 308 represents a general packet network. The packet network may include access to packet networks owned by other service providers, as well as the Internet and PSTN, via trunking gateways 312, as will be appreciated by a person skilled in the art.

The host digital terminals 304 provide support for high capacity connections, such as T1 circuits for example, to the integrated digital terminals 306. The remote terminals 302 provide support for end-user loops 108, or subscribers. Thus, the present configuration uncouples the direct relationship between the host digital terminals 304 and the remote terminals 302. As a result, a control mechanism is used to couple the host digital terminals 304 and the remote terminals 302. Such a control mechanism is provided by the distribution network 308. The distribution network 308 is capable of coupling any of the remote terminals 302 with any of the host digital terminals 304. Further, it is preferable that call-control between the remote terminal 302 and a corresponding host digital terminal 304 uses a common open standard protocol. In the present embodiment, these protocols include gateway control signal protocols such as MGCP and MEGACO/H.248.

The host digital terminal 304 supports integrated network access (INA), TR08, GR303, PRI, E1 CAS and V5 interface groups for communicating with the IDT 306 and contains at least one timeslot interchanger (TSI) for DS0 cross connects. The above standards are well known in the art and thus will only be described briefly herein. INA is a method of unbundling DS0s into INA groups as D4 framed DS1s. An INA group typically contains between 1and 28 DS1s. INA is protocol supported so that a service provider can unbundle the loops to a channel bank to provide an analog handoff to an alternate service provider if required. TR08 interface is an IDLC configuration that is derived from Lucent Technologies SLC96™ DLC products. TR08mode 1 consists of four DS1s (96 DSOs) that serve up to 96 lines with no concentration. TR08mode 2 uses two DS1s (48 DSOs) that serve up to 96 lines providing 2:1 concentration. A GR303 interface is an IDLC configuration that is the successor to TR08. GR303 supports between 2 and 28 DS1s, 1 to 2048 lines with up to 9:1 concentration. Two of the T1 links used in an interface group contain a Timeslot Management Channel (TMC) used for call processing and an Embedded Operations Channel (EOC) used for management. Each of these channels occupies a DS0. Primary rate interface (PRI) is an Integrated Services Digital Network (ISDN) level of service typically used for connecting businesses with a central office. E1 Channel Associated Signaling (CAS) is a system in which control signals are transmitted in the same channel as the data and voice signals.

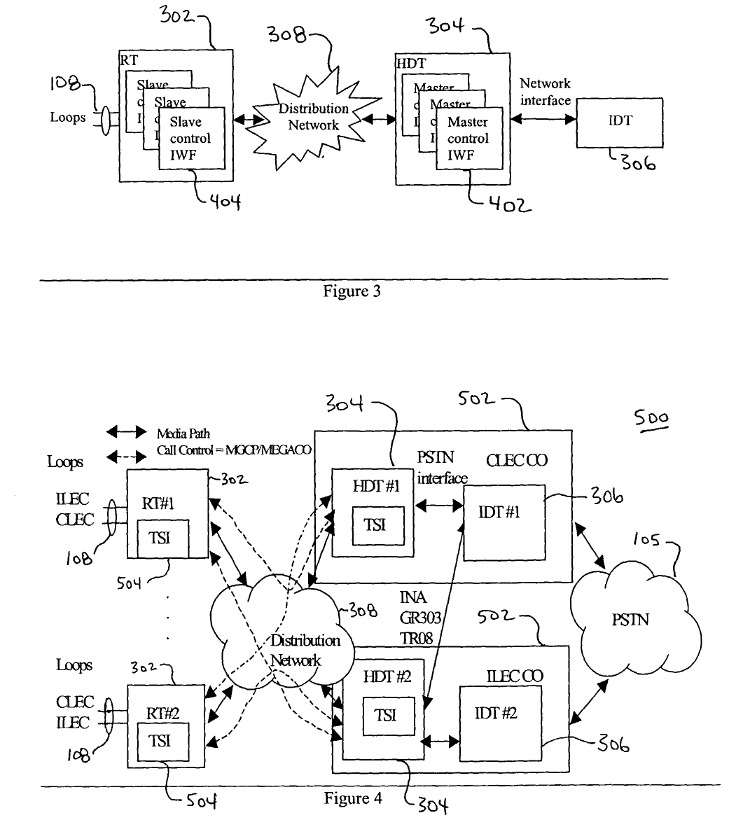

Referring to FIG. 3, a decomposed host digital terminal 304 and remote terminal 302 system is illustrated. The host digital terminal 304 includes a plurality of master control internetworking functions (IWF) 402, and the remote terminal 302 includes a plurality of slave control internetworking functions (IWF) 404. Thus, the gateway control protocol is based on a master-slave relationship between the host digital terminal 304 and its remote terminals 302.

The master control components 402 provide an internetworking function between the signaling protocol used by the IDT 306 and a gateway control signaling protocol. That is, the master control IWF 402 provides a translation between the signaling protocol used by the IDT 306 and the gateway control signaling protocol, and vice versa. Given that the gateway control signaling protocol provides a fixed application programming interface (API), the master control IWF's role is to map appropriate IDT-generated signaling protocol commands to the equivalent gateway control signaling protocol. All necessary provisioning information is entered in the host digital terminal 304 to allow the translation to occur. The gateway control signaling protocol APIs include call setup, event notification, audits and the like, as will be appreciated by a person skilled in the art.

Therefore, whenever a master control IWF API is called, the master control IWF 402 translates the address and command used by the IDT signaling protocol to the format of the address and command used by the gateway control signaling protocol. At this point, the gateway control signaling protocol uses its messaging interface to route the signaling request to a corresponding slave control IWF 404, located in the remote terminal 302.

Similarly, the role of the slave control IWF 404 includes mapping appropriate loop generated protocol commands and addresses to the equivalent gateway control signaling protocols and commands, and vise versa. Again, all necessary provisioning information is entered to the remote terminal 302 to allow this translation to occur.

An example of the functionality of the master control IWF 402 is as described as follows, with reference to an IDT-originated call setup. In the present example, the IDT 306 uses GR303 signaling protocol, and the gateway control signaling protocol is Media Gateway Control Protocol (MGCP). To perform a call setup, a GR303 “SETUP” message is used to assign an IDT DS1/DS0 timeslot to a selected remote terminal analog line. The “SETUP” message includes a Call Reference Value (CRV), which is a number used to address the selected analog line. MGCP uses a gateway identifier and an endpoint identifier to represent the selected analog line. The master control IWF 402 is provisioned such that it maintains a mapping from the CRV to the MGCP line address parameters. Further, the master control IWF maintains a mapping from various GR303 commands to associated MGCP APIs.

Once the master control IWF translation is completed, the master control IWF 402 uses the MGCP primitive CRCX as the “Create Connection” command for sending the call setup request to the remote terminal 302. The slave control IWF 404 at the corresponding remote terminal 302 receives this message and performs the DS1/DS0 cross connect function to the selected analog line. If the cross connect is successful, the slave control IWF 402 notifies the master control IWF 402 using the MGCP response primitive for CRCX. Once the master control IWF 402 receives this message, it notifies the GR303 interface that the connection on the remote terminal 302 has been achieved successfully. That is, the master control IWF 402 translates the response received from the slave control IWF 404 to a GR303 “CONNECT” message for the corresponding CRV. The “CONNECT” message is communicated to the IDT 306. At this point, a call setup using the master and slave control IWFs 402 and 404 is complete.

Alternately, it is possible for a remote terminal 302 to initiate a connection. The function of the master and slave control IWFs 402 and 404 is similar to that described in the previous example. If, for example, an off-hook is detected on the remote terminal 302, the slave control IWF 404 maps the analog line to the MGCP-based line address and performs a lookup to the associated destination address of the master control IWF 402. The slave control IWF 404 sends a message to the master control IWF 402 using the MGCP primitive NTFY as the “Notify” command. The master control IWF 402 translates the received MGCP address to a corresponding GR303 CRV. The master control IWF 402 performs a timeslot request to the IDT 306 using the GR303 “SETUP” message with the translated CRV as a parameter. At this point, a DS1/DS0 timeslot is assigned following a similar sequence to the IDT-originated call setup, as previously described.

One advantage of the system described above is that it simplifies the ability to unbundle the loops 108. For example, referring once again to FIG. 2, a loop 108 coupled to one of the remote terminals 302 can be coupled to either of the host digital terminals 304, depending on the provisioning at the remote terminal 302. That is, since the slave control IWF 404 maps the loop 108 to a MGCP-based line address for an associated master control IWF 402, all that is required to change host digital terminals 304 is to change the mapping at the remote terminal 302. Therefore, a customer can be moved from a first host digital terminal 304 operated by an incumbent local exchange carrier (ILEC) to a second host digital terminal 304 operated by a competitive local exchange carrier (CLEC) by a provisioning change sent from a management system. Implementing this feature on the management system varies depending on the implementation, as will be appreciated by a person skilled in the art.

A further advantage of the system is that in addition to the ability to unbundle the loops 108, it enables service providers to shift technology from traditional voice systems to packet-based voice systems on a line-by-line basis. Thus, service providers can offer new services to their customers without having to maintain separate systems for new and old technology. For example, a loop 108 coupled to one of the remote terminals 302 is to be changed from traditional voice service to packet voice service. The management system sends a provisioning change to the remote terminal 302, instructing it that the loop 108 will be communicating using packet voice technology. The remote terminal 302 is provisioned with sufficient instructions to perform the packet voice communication, which is generally a superset of the instructions required for traditional voice communication described above. This is possible because the gateway control signaling protocol used for the distribution network 308 is designed for packet voice communication.

When the remote terminal 302 receives instructions from the loop 108 for establishing a connection, the remote terminal 302 uses MGCP to transmit the request to the softswitch 310 in the distribution network 308. If the softswitch 310 determines that the destination address is a traditional packet voice enabled remote terminal 302, the softswitch 310 establishes a connection with the PSTN 105 via the trunking gateway 312 as is standard in the art. If the softswitch 310 determines that the destination address is another packet voice enabled remote terminal 302, the softswitch 310 establishes a connection directly with the remote terminal 302 as will be appreciated by a person skilled in the art.

Yet a further advantage of the present embodiment of the system is that the gateway control signaling protocol used for the distribution network is an open standard. Therefore, the system provides for easy interoperability with third party systems. For example, a third party host digital terminal 304 can easily be integrated into the system by designing an interface between the protocol of the third party host digital terminal 304 and the known open standard.

Yet a further advantage of the system is the ability of the host digital terminal 304 to use the gateway control protocol for controlling loop maintenance activities on loops serviced by a given remote terminal 302. Loop testing can performed by translating the IDT signaling protocol into call setup requests from the host digital terminal 304 to the remote terminal 302. The protocol translation occurs in a similar fashion to that for gateway control signaling. In order to perform loop testing at the remote terminal 302, the analog lines are cross-connected to metallic test access ports (MTAPs) for the duration of the loop tests. The MTAPs are set up such that they can be addressed as an endpoint to which an analog line can cross connect. The same gateway control protocol signaling primitives can be used for loop testing as are used for call processing. The master control IWF 402 translates the IDT loop testing message protocol to the gateway control protocol primitives used for call setup. The master control IWFs 402 and slave control IWFs 404 are provisioned so that these translations can occur.

Referring to FIG. 4, an alternate embodiment is illustrated generally by numeral 500. In the present embodiment, a central office (CO) 502 comprises a plurality of IDTs 306. A first IDT 306 and a first host digital terminal 304 reside with a CLEC, or alternate service provider. A second IDT 306 and a second host digital terminal 304 reside with an ILEC, or primary service provider. The host digital terminals 304 are coupled to a plurality of remote terminals 302 via a distribution network 308. Each of the remote terminals 302 is coupled with loops 108 that may be destined to either ILEC or CLEC customers, or both.

The remote terminals 302 further include a timeslot interchanger (TSI) 504. The TSI 504 is used for grouping loops 108 together so that they can be unbundled as one digital handoff through the distribution network 308. Thus, the remote terminal 302 may be partitioned in such a way that each type of customer loop 108 is grouped together. That is, ILEC customer loops 108 are grouped together and CLEC customer loops 108 are grouped together. Furthermore, since there may be more than one CLEC, the customer loops 108 of one CLEC are grouped separately from those of other CLECs. The remote terminal 302 is partitioned such that a different host digital terminal 304 can control each partition.

Furthermore, having a TSI 504 at the remote terminal 302 enables loop concentration to be performed at the remote terminal 302 instead of at the host digital terminal 304, where use of distribution network bandwidth is not economical. That is, data from a host digital terminal 304 destined for multiple loops 108 at the same remote terminal 302 can be transmitted to that remote terminal 302 via one or more paths in the distribution network 308. Once the data arrives at the remote terminal 302, the TSI 504 routes the data to corresponding loops 108. Typically, the number of paths used in such a case is less than if there was no TSI 504 at the remote terminal 302, in which case the host digital terminal 304 has to use separate paths for each loop destination.

In the embodiments described above, the protocol used for the distribution network 308 is preferably either Media Gateway Control Protocol (MGCP) or Media Gateway Control (MEGACO)/H.248. The protocol selected is not limited to these protocols, but they are preferable for several reasons. As previously described, these protocols are an open standard and thus can be readily implemented by a person skilled in the art. This leads to compatibility and interoperability with third party products, since even if the third party product use proprietary protocols, these protocols can be mapped to MGCP or MEGACO/H.248 for connecting to the distribution network 308. Using open standards protocols also reduces product development time by enabling the use of off-the-shelf protocol software.

Furthermore, MGCP and MEGACO/H.248 are reliable and robust and allow the distribution network 308 to be scaled. They are independent of the transport network and the type of media carried. Therefore, the protocols can be applied to traditional voice communication as well as packet voice communication. Furthermore, MGCP and MEGACO/H.248 are useful because they can be carried on all media that support IP traffic. Thus, they can be used with various carrier networks such as ATM, Ethernet, TDM, Synchronous Optical Network (SONET), and wireless protocols, as well as future protocols that may be developed for supporting IP traffic, as will become apparent to a person skilled in the art. Such adaptability provides for system flexibility. MGCP and MEGACO/H.248 also support call control, loop testing and maintenance operations. Lastly, they are able to evolve to support next-generation voice over packet network applications.

Although the invention has been described with reference to certain specific embodiments, various modifications thereof will be apparent to those skilled in the art without departing from the spirit and scope of the invention as outlined in the claims appended hereto.

What is claimed is:

1. A distributed system for communicating between a host digital terminal and a remote terminal, said host digital terminal coupled between a central office digital terminal and a distribution network, said remote terminal coupled between said distribution network and a plurality of subscriber loops, said system comprising:
(a) a first network interface in communication with said host digital terminal for translating between an interface group protocol and a gateway control protocol; and
(b) a second network interface in communication with said remote terminal for translating between a remote terminal protocol and said gateway control protocol;
wherein said distribution network uses said gateway control protocol for routing data between said host digital terminal and said remote terminal in accordance with a destination address of said data.

2. A system as defined in claim 1, wherein said gateway control protocol is a packet based protocol.

3. A system as defined in claim 2, wherein said distribution network routes packet voice communication from said second network interface to a trunking gateway for transmitting to a PSTN, when said destination address is a PSTN voice communication address.

4. A system as defined in claim 3, where said gateway control protocol is one of a MGCP protocol and a MEGACO/H.248 protocol.

5. A system as defined in claim 2, wherein said distribution network routes packet voice communication from said second network interface to another second network interface associated with said destination address, when said destination address is a packet voice communication address.

6. A system as defined in claim 5, where said gateway control protocol is one of a MGCP protocol and a MEGACO/H.248 protocol.

7. A system as defined in claim 1, wherein said distribution network routes Public Switched Telephone Network (PSTN) voice communication from said second network interface to said first network interface for transmitting to a PSTN.

8. A system as defined in claim 1, wherein said host digital terminal further includes a timeslot interchanger for routing data to a corresponding subscriber loop.

9. A system as defined in claim 1, wherein said host digital terminal further includes a timeslot interchanger for routing data to a corresponding remote terminal and said corresponding remote terminal further includes a timeslot interchanger for routing data to associated subscriber loops.

10. A system as defined in claim 9, wherein said corresponding remote terminal is partitioned by grouping said associated subscriber loops in accordance with a service provider thereof.

11. A system as defined in claim 10, wherein said distribution network is capable of switching any of a plurality of host digital terminals with any of a plurality of remote terminal partitions.

12. A system as defined in claim 1, wherein said interface group protocol is one of an INA protocol, a GR303 protocol, a TR08 protocol, a PRI protocol, an E1 CAS protocol, and a V5 protocol.

13. A system as defined in claim 1, wherein said distribution network is capable of switching any of a plurality of host digital terminals with any of a plurality of remote terminals.

14. A system as defined in claim 1, wherein a transport protocol for said distribution network is at least one of an ATM protocol, an Ethernet protocol, a TDM protocol, a SONET protocol, and a wireless protocol.
